(19) United States
(12) Patent Application Publication
(10) Pub. No.: US 2014/0222266 A1
(43) Pub. Date: Aug. 7, 2014

(54) INTEGRATED ELECTRONIC POWER CONTROL UNIT OF ENVIRONMENTALLY-FRIENDLY VEHICLE

(71) Applicants: KIA MOTORS CORPORATION, Seoul (KR); HYUNDAI MOTOR COMPANY, Seoul (KR)

(72) Inventors: Bum Sik Kim, Gwangmyeong (KR); Jaewon Lee, Hwaseong (KR); Ki Jong Lee, Osan (KR); Tae Hwan Chung, Incheon (KR)

(73) Assignees: KIA MOTORS CORPORATION, Seoul (KR); HYUNDAI MOTOR COMPANY, Seoul (KR)

(21) Appl. No.: 14/065,783

(22) Filed: Oct. 29, 2013

(30) Foreign Application Priority Data
Feb. 6, 2013 (KR) 10-2013-0013415

(51) Int. Cl. B60W 20/00; B60W 10/08; B60W 10/06

(52) U.S. Cl. CPC B60W 20/00; B60W 10/06; B60W 10/08; Y10S 903/93
USPC 701/22; 903/930

(57) ABSTRACT

An integrated electronic power control unit of an environmentally-friendly vehicle that may reduce costs and enhance structure and space utilization by integrally configuring at least two or more electronic power control units (EPCUs) disposed within the environmentally-friendly vehicle. The integrated electronic power control unit (EPCU) includes a plurality of EPCUs such as a motor control unit (MCU), a low voltage DC-DC converter (LDC), or a hybrid control unit (HCU), wherein at least one or more components of the plurality of EPCUs are integrated. In addition, the integrated electronic power control unit includes a hardware failure management unit (HFM) that is configured to detect and manage a failure of hardware including the at least one or more integrated components.

### CROSS-REFERENCE TO RELATED APPLICATION

This application claims priority to and the benefit of Korean Patent Application No. 10-2013-0013415 filed in the Korean Intellectual Property Office on Feb. 6, 2013, the entire contents of which are incorporated herein by reference.

### BACKGROUND

(a) Field of the Invention

The present invention relates to an integrated electronic power control unit of environmentally-friendly vehicle that reduces cost and improves structure and space utilization by integrally configuring at least two or more electronic power control units (EPCUs) disposed within an environmentally-friendly vehicle.

(b) Description of the Related Art

As known, environmentally-friendly vehicles having enhanced mileage, satisfying on board diagnosis (OBD) regulations with respect to discharge gas, and minimizing the use of fossil fuel have been developed. Environmentally-friendly vehicles, including a fuel cell vehicle, an electric vehicle, a plug-in electric vehicle, a hybrid vehicle, include one or more motors and engines.

An environmentally-friendly vehicle includes a battery that stores power having a high voltage for driving a motor, an inverter that converts a DC voltage of the battery into an AC voltage, an engine clutch installed between an engine and the motor to transmit power from the engine to a driving shaft, and various electronic power control units that control an operation of the environmentally-friendly vehicle.

An environmentally-friendly vehicle may provide an operation of a hybrid electric vehicle (HEV) mode and an electric vehicle (EV) mode by connecting or releasing an engine clutch according to a driver acceleration and deceleration intention determined based on a manipulation of an accelerator pedal and a brake pedal by the driver, a load, a vehicle speed, a stage of charge (SOC) of a vehicle, and the like.

In an environmentally-friendly vehicle, when an operation of an EV mode to an operation of an HEV mode, an engine clutch is connected after an engine speed and a motor speed are synchronized to prevent torque fluctuation in a process of transmitting power between the engine and the motor as different power sources, thus securing drivability (or operability). Such an environmentally-friendly vehicle includes various electric power control units (EPCUs) that operate an engine, a motor, a transmission, a battery, and the like. FIG. 1 illustrates the location of the EPCUs within the vehicle.

In FIG. 1, reference numeral 15 denotes an engine control unit (ECU) 15 that operates an engine 10, reference numeral 25 denotes a motor control unit (MCU) 25 that operates a motor 20, reference numeral 35 denotes a transmission control unit (TCU) 35 that operates a transmission 30, reference numeral 45 denotes a high voltage battery control unit (BCU) 45 that manages and operates a high voltage battery 40, reference numeral 55 denotes a low voltage DC-DC converter (LDC) 55 that converts a voltage of the high voltage battery 40 into a low voltage (e.g., 12V) to charge a low voltage battery 50, and reference numeral 100 denotes a hybrid control unit (HCU) 100 that monitors and controls an overall operation of a hybrid vehicle.

The MCU 25 may generally be called an inverter. The high voltage BCU 45 may be called a battery management system (BMS). In addition, the respective electronic power control units are generally known to a person skilled in the art, and thus detailed descriptions thereof will be omitted.

As illustrated in FIG. 2(A), in general, the MCU 25 may include a control power source unit, a boost power source unit, a main central processing unit (MCU), a sub-CPU, a resolver, a protective/diagnosing unit, and the like. In addition, as illustrated in FIG. 2(B), in general, the LDC 55 may include a control power source unit, a boost power source unit, a CPU, an analog control unit, a protective/diagnosing unit, and the like. As illustrated in FIG. 2(C), in general, the HCU 100 may include a control power source unit, a memory such as an SRAM, a CPU, an interface circuit unit, and the like. Referring to FIG. 2, the MCU 25, the LDC 55, and the HCU 100 include elements executing similar functions.

However, the EPCUs, in particular, the MCU 25, the LDC 55, and the HCU 100, disposed within an environmentally-friendly vehicle exist as individual elements as illustrated in FIG. 1, thus increasing costs of the environmentally-friendly vehicle and decreasing space utilization of the environmentally-friendly vehicle.

Matters described in the background part are drawn up to help understand background of the invention and may include matters of the related art not known to a person skilled in the art.

The above information disclosed in this Background section is only for enhancement of understanding of the background of the invention and therefore it may contain information that does not form the prior art that is already known in this country to a person of ordinary skill in the art.

### SUMMARY

The present invention provides an integrated electronic power control unit of environmentally-friendly vehicle having advantages of achieving cost reduction and structure optimization and enhancing space utilization by integrally configuring at least two or more electronic power control units (EPCUs) disposed within an environmentally-friendly vehicle.

An exemplary embodiment of the present invention provides an integrated electronic power control unit (EPCU) of an environmentally-friendly vehicle that may include at least two or more EPCUs such as a motor control unit (MCU), a low voltage DC-DC converter (LDC), or a hybrid control unit (HCU), including: one or more integrated components configured by integrating components commonly included in the at least two or more EPCUs; and a hardware failure management unit (HFM) configured to detect and manage a failure of hardware including the at least one or more integrated components.

The integrated component may include an integrated control power source unit configured to integrally perform functions of control power source units respectively included in the MCU, the LDC, and the HCU. In addition, the integrated component may include an integrated boost power source unit configured to integrally perform functions of boost power source units respectively included in the MCU and the LDC. The integrated component may include an integrated central processing unit (CPU) configured to integrally perform functions of CPUs respectively included in the MCU and the HCU. Further, the integrated EPCU may be configured to integrally perform functions of the MCU, the LDC, and the HCU.

According to embodiments of the present invention, since at least two or more EPCUs disposed within an environmentally-friendly vehicle may be integrated, a cost reduction and structure optimization may be achieved and space utilization may be enhanced.

In particular, according to an embodiment of the present invention, since communication lines among or between an inverter, an LDC, and an HCU as in the related art are not required, relevant hardwires may be omitted, and thus, reliability of the device may be enhanced. Additionally, since the integrated EPCU may be used to communicate with a different controller such as an ECU, a TCU, a BMS, or the like, communication reliability through sharing of a communication line may be enhanced. Further, a power source circuit design of the integrated EPCU may be improved using a dry film solder mask DFSS, and thus reliability of circuit designing may be enhanced.

### BRIEF DESCRIPTION OF THE DRAWINGS

FIG. 1 is an exemplary view illustrating a configuration of electronic power control units (EPCUs) disposed within a general environmentally-friendly vehicle according to the related art;

FIG. 2 is an exemplary block diagram illustrating elements of EPCUs disposed within the general environmentally-friendly vehicle accordingly to the related art;

FIG. 3 is an exemplary view illustrating a configuration of integrated EPCUs of an environmentally-friendly vehicle according to an exemplary embodiment of the present invention;

FIG. 4 is an exemplary view illustrating a configuration of the integrated EPCUs of the environmentally-friendly vehicle according to an exemplary embodiment of the present invention; and

FIG. 5 is an exemplary view illustrating a configuration of a printed circuit board (PCB) of integrated EPCUs of the environmentally-friendly vehicle according to an exemplary embodiment of the present invention.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. Throughout the specification, elements denoted by the same reference numerals indicate the same elements.

Throughout the specification, unless explicitly described to the contrary, the word “comprise” and variations such as “comprises” or “comprising,” will be understood to imply the inclusion of stated elements but not the exclusion of any other elements.

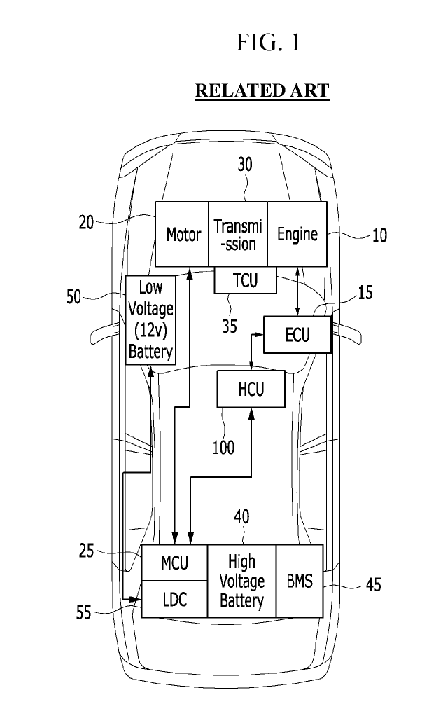

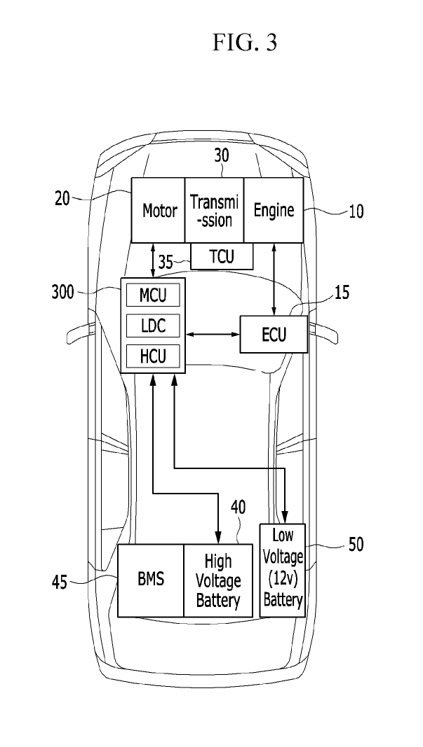

FIG. 3 is an exemplary view illustrating a configuration of integrated electronic power control units (EPCUs) of an environmentally-friendly vehicle according to an exemplary embodiment of the present invention. A comparison between a configuration of the integrated EPCUs illustrated in FIG. 3 and that of the EPCUs illustrated in FIG. 1 shows that the MCU 25, the LDC 55, and the HCU 100 illustrated in FIG. 1 are integrated into an integrated EPCU 300. When the integrated EPCU 300 is configured to incorporate functions of the MCU 25, the LDC 55, and the HCU 100, space utilization of the environmentally-friendly vehicle may be increased as illustrated in FIG. 3.

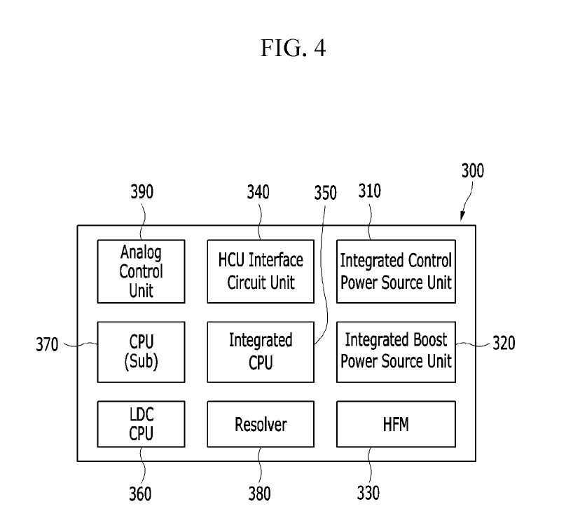

FIG. 4 is an exemplary block diagram of an integrated EPCU of an environmentally-friendly vehicle according to an exemplary embodiment of the present invention. Referring to FIG. 4, the integrated EPCU 300 of an environmentally-friendly vehicle may integrate an MCU, an LDC, and an HCU. In other words, the integrated EPCU 300 may be configured to convert a voltage of a high voltage battery into a lower voltage to charge a low voltage battery and monitor and control power distribution of a hybrid vehicle and a state of an electric power unit, as well as controlling an operation of a motor.

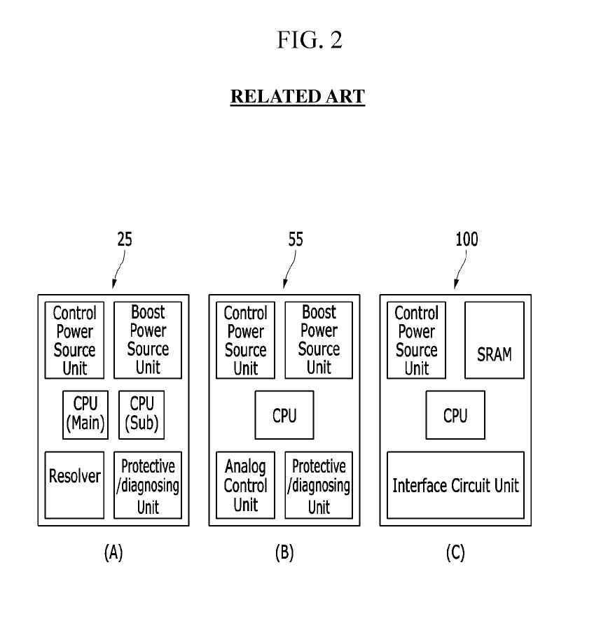

In particular, the integrated EPCU 300 may include an integrated control power source unit 310 configured integrally perform functions of the control power source units respectively included in the general MCU 25, the LDC 55, and the HCU 100 as illustrated in FIG. 2, an integrated boost power source unit 310 configured to integrally perform functions of the boost power source units respectively included in the MCU 25 and the LDC 55, an integrated CPU 350 configured to integrally perform functions of the CPUs respectively included in the CU 25 and the HCU 100, and a hardware failure management unit (HFM) 330 configured to detect and manage a failure of integrated hardware of the EPCU 300.

Additionally, the integrated EPCU 300 may include a resolver 380 and a sub-CPU 370 generally included in the MCU 25, an analog control unit 390 generally included in the LDC 55, and a hybrid interface circuit unit 350 generally included in the HDC 100.

A comparison between the components of the integrated EPCU 300 illustrated in FIG. 4 and the components of the independent (e.g., not integrated) EPCU 300 illustrated in FIG. 2 shows that, in the integrated EPCU 300, one protective/diagnosing unit included in the independent EPCU 300 was removed, two control power source units were removed, and one boost power source unit was removed. In other words, the integrated EPCU 300 according to an exemplary embodiment of the present invention is an apparatus optimized by integrating the control power source units respectively included in the independent EPCUs 300 structurally/functionally (or by commonly using them), thus omitting various separate components of the related art.

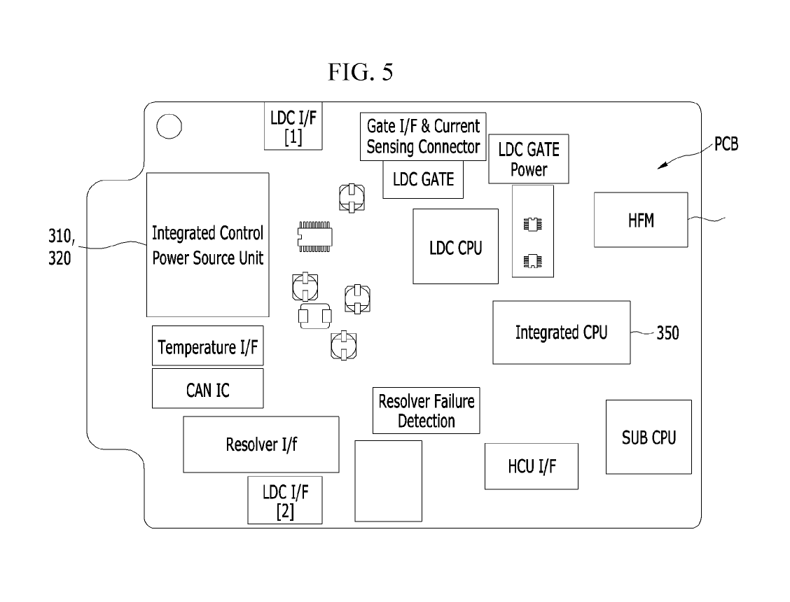

FIG. 5 is an exemplary view showing a configuration of an integrated EPCU of an environmentally-friendly vehicle on a printed circuit board (PCB) according to an exemplary embodiment of the present invention. In FIG. 5, an LDC I/F denotes a low voltage DC-DC converter interface, and CAN IC denotes a control unit area network IC.

Referring to FIG. 5, since the integrated control power source unit 310 that integrally performs functions of the MCU, the LDU, and the HCU, the integrated boost power source unit 320, and the integrated CPU 350 are formed on a printed circuit board (PCB), the size PCB may be reduced to enhance space utilization and reduce costs of a material of the PCB.

According to an exemplary embodiment of the present invention, since the manufacturing process and/or work effort may be simplified, as well as reducing costs of a material of the EPCU, labor costs may be reduced and a defective rate of the EPCU due to the process simplification may be reduced. Additionally, according to an exemplary embodiment of the present invention, cost of labor in case of an after-sale service may be reduced. Further, according to an exemplary embodiment of the present invention, since communication lines between or among the MCU, the LDC, and the HCU configured as separately independent EPCUs may not be required, hard wires in relation to communication may be omitted, and thus, communication reliability may be enhanced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

300: integrated electronic power control unit

310: integrated control power source unit

320: integrated boost power source unit

330: hardware failure managing unit

350: integrated central processing unit

What is claimed is:

1. An integrated electronic power control unit (EPCU) of a vehicle including:
a plurality of EPCUs including a motor control unit (MCU), a low voltage DC-DC converter (LDC), and a hybrid control unit (HCU), wherein at least one or more components of the plurality of EPCUs are integrated; and
a hardware failure management unit (HFM) configured to detect and manage a failure of hardware including the at least one or more integrated components.

2. The integrated electronic power control unit of claim 1, wherein the integrated component includes an integrated control power source unit configured to integrally perform functions of control power source units respectively included in the MCU, the LDC, and the HCU.

3. The integrated electronic power control unit of claim 2, wherein the integrated component includes an integrated boost power source unit configured to integrally perform functions of boost power source units respectively included in the MCU and the LDC.

4. The integrated electronic power control unit of claim 3, wherein the integrated component includes an integrated central processing unit (CPU) configured to integrally perform functions of CPUs respectively included in the MCU and the HCU.

5. The integrated electronic power control unit of claim 4, wherein the integrated EPCU is configured to:
convert a voltage of a high voltage battery to a lower voltage to charge a low voltage battery; and
monitor and control power distribution of the vehicle, a state of the EPCU, and operation of a vehicle motor.

6. The integrated electronic power control unit of claim 4, wherein the integrated EPCU is configured to integrally perform functions of the MCU, the LDC, and the HCU.

7. An integrated electronic power control unit (EPCU) of a vehicle including:
at least two or more EPCUs, including a motor control unit (MCU), a low voltage DC-DC converter (LDC), and a hybrid control unit (HCU), wherein at least one or more components of the at least two or more EPCUs are integrated and the EPCUs are configured to integrally perform functions of the MCU, the LDC, and the HCU.

8. The integrated electronic power control unit of claim 7, wherein a failure of hardware of the at least one or more integrated components is detected and managed by a hardware failure management unit.

9. The integrated electronic power control unit of claim 7, wherein the integrated components includes an integrated control power source unit configured to integrally perform functions of control power source units respectively included in the MCU, the LDC, and the HCU.

10. The integrated electronic power control unit of claim 8, wherein the integrated components includes an integrated boost power source unit configured to integrally perform functions of boost power source units respectively included in the MCU and the LDC.

11. The integrated electronic power control unit of claim 9, wherein the integrated components includes an integrated central processing unit (CPU) configured to integrally perform functions of CPUs respectively included in the MCU and the HCU.
